(19) United States
(12) Patent Application Publication
(10) Pub. No.: US 2019/0166373 A1
(43) Pub. Date: May 30, 2019

(54) IMAGE ENCODING/DECODING METHOD AND APPARATUS AND IMAGE PROCESSING EQUIPMENT

(71) Applicant: FUJITSU LIMITED, Kawasaki-shi (JP)

(72) Inventors: Jianqing ZHU, Beijing (CN); Zheng WANG, Beijing (CN); Kimihiko KAZUI, Kawasaki-shi (JP)

(73) Assignee: FUJITSU LIMITED, Kawasaki-shi (JP)

(21) Appl. No.: 16/262,343

(22) Filed: Jan. 30, 2019

Related U.S. Application Data
(63) Continuation of application No. PCT/CN2016/101990, filed on Oct. 13, 2016.

(51) Int. Cl. H04N 19/159; H04N 19/184; H04N 19/11

(52) U.S. Cl. CPC H04N 19/159; H04N 19/129; H04N 19/11; H04N 19/184

(57) ABSTRACT

An image encoding/decoding method and apparatus and image processing equipment, in which encoding/decoding is/are performed on a plurality of sub-predicting units of a predicting unit in an intra prediction manner. The image encoding method includes: determining a prediction mode of the predicting unit;

respectively calculating residual information on the plurality of sub-predicting units of the predicting unit; and encoding information on the prediction mode of the predicting unit and the residual information on the plurality of sub-predicting units into a bit steam. Hence, an intra prediction result may be provided more accurately without increasing overmuch encoding cost.

### CROSS-REFERENCE TO RELATED APPLICATIONS

This application is a continuation application of International of PCT International Application No. PCT/CN2016/101990, filed Oct. 13, 2016, the disclosure of which is incorporated herein by reference.

### FIELD

This disclosure relates to the field of picture and image technologies, and in particular to an image encoding/decoding method and apparatus and an image processing equipment.

### BACKGROUND

In video coding (also referred to as image coding) standards (such as MPEG 2, H.264/AVC, and H.265/HEVC), intra coding (hereinafter also referred to as intra prediction coding) predicts a current block to be encoded by using reconstructed neighboring pixels, which may be referred to as a prediction unit (PU).

FIG. 1 is a schematic diagram of an intra prediction mode. As shown in FIG. 1, a block to be coded (PU) may be predicted by reconstructed neighboring pixels. A coding unit (CU) may be predicted by one PU, or may be predicted by a plurality of PUs.

FIG. 2 is a schematic diagram of a relationship between a CU and a PU. As shown in FIG. 2, one CU may be predicted by one or four PU(s); each PU has prediction mode of its own. When the intra coding mode is used, a coding device first determines a prediction mode of the prediction unit and residual information, and then encodes the information into a bit stream (also referred to as a code stream); and a decoding device obtains information on the prediction mode and residual information of the prediction unit from the bit stream, reconstructs an image based on the information.

It should be noted that the above description of the background is merely provided for clear and complete explanation of this disclosure and for easy understanding by those skilled in the art. And it should not be understood that the above technical solution is understandable to those skilled in the art.

### SUMMARY

However, it was found by the inventors that an existing scheme takes a prediction unit as a granularity to perform intra prediction. If the prediction unit is relatively large, which will result in an inaccurate prediction result, and if the prediction unit is relatively small, more prediction mode information and residual information need to be programmed into a bit stream, which will cause an encoding cost (or referred to as a bit cost) to become larger.

Embodiments of this disclosure provide an image encoding/decoding method and apparatus image processing equipment, in which it is expected that a more accurate intra prediction result can be provided without increasing overmuch encoding cost.

According to a first aspect of the embodiments of this disclosure, there is provided an image encoding method, in which encoding is performed on a plurality of sub-predicting units of a predicting unit in an intra prediction manner, the image encoding method including:

determining a prediction mode of the predicting unit;

respectively calculating residual information on the plurality of sub-predicting units of the predicting unit; and

encoding information on the prediction mode of the predicting unit and the residual information on the plurality of sub-predicting units into a bit steam.

According to a second aspect of the embodiments of this disclosure, there is provided an image encoding apparatus, which is configured to perform encoding on a plurality of sub-predicting units of a predicting unit in an intra prediction manner, the image encoding apparatus including:

a mode determining portion configured to determine a prediction mode of the predicting unit;

an information calculating portion configured to respectively calculate residual information on the plurality of sub-predicting units of the predicting unit; and

a bit stream encoding portion configured to encode information on the prediction mode of the predicting unit and the residual information on the plurality of sub-predicting units into a bit steam.

According to a third aspect of the embodiments of this disclosure, there is provided an image decoding method, in which decoding is performed on a plurality of sub-predicting units of a predicting unit in an intra prediction manner, the image decoding method including:

obtaining information on a prediction mode of the predicting unit and residual information on the plurality of sub-predicting units of the predicting unit from a bit stream; and

respectively calculating reconstructed images of the sub-predicting units according to the prediction mode of the predicting unit and the residual information on the plurality of sub-predicting units.

According to a fourth aspect of the embodiments of this disclosure, there is provided an image decoding apparatus, which is configured to perform decoding on a plurality of sub-predicting units of a predicting unit in an intra prediction manner, the image decoding apparatus including:

an information acquiring portion configured to obtain information on a prediction mode of the predicting unit and residual information on the plurality of sub-predicting units of the predicting unit from a bit stream; and

an image reconstructing portion configured to respectively calculate reconstructed images of the sub-predicting units according to the prediction mode of the predicting unit and the residual information on the plurality of sub-predicting units.

According to a fifth aspect of the embodiments of this disclosure, there is provided an image processing equipment, including:

an encoder including the image encoding apparatus as described above; and/or

a decoder including the image decoding apparatus as described above.

According to another aspect of the embodiments of this disclosure, there is provided a computer readable program code, which, when executed in an image encoding apparatus or image processing equipment, will cause the image encoding apparatus or the image processing equipment to carry out the image encoding method as described above.

According to a further aspect of the embodiments of this disclosure, there is provided a storage medium storing a computer readable program code, which will cause an image encoding apparatus or image processing equipment to carry out the image encoding method as described above.

According to still another aspect of the embodiments of this disclosure, there is provided a computer readable program code, which, when executed in an image decoding apparatus or image processing equipment, will cause the image decoding apparatus or the image processing equipment to carry out the image decoding method as described above.

According to a further aspect of the embodiments of this disclosure, there is provided a storage medium storing a computer readable program code, which will cause an image decoding apparatus or image processing equipment to carry out the image decoding method as described above.

An advantage of the embodiments of this disclosure exists in that a prediction mode of the predicting unit is determined, residual information on a plurality of sub-predicting units of the predicting unit is respectively calculated, and information on the prediction mode of the predicting unit and the residual information on the plurality of sub-predicting units are encoded into a bit steam. Hence, an intra prediction result may be provided more accurately without increasing overmuch encoding cost.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of this disclosure. To facilitate illustrating and describing some parts of the disclosure, corresponding portions of the drawings may be exaggerated or reduced.

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a schematic diagram of an intra prediction mode;

FIG. 2 is a schematic diagram of a relationship between a CU and a PU;

FIG. 3 is a schematic diagram of performing encoding by using an intra prediction manner;

FIG. 4 is a schematic diagram of performing decoding by using an intra prediction manner;

FIG. 5 is a flowchart of an image encoding method according to an embodiment of this disclosure;

FIG. 6 is a schematic diagram of a relationship between a PU and sub-PUs according to an embodiment of this disclosure;

FIG. 7 is another flowchart of the image encoding method according to an embodiment of this disclosure;

FIG. 8 is a schematic diagram of raster scan modes according to an embodiment of this disclosure;

FIG. 9 is a schematic diagram of Z-type scan modes according to an embodiment of this disclosure;

FIG. 10 is another flowchart of an image encoding method according to an embodiment of this disclosure;

FIG. 11 is a flowchart of an image decoding method according to an embodiment of this disclosure;

FIG. 12 is another flowchart of an image decoding method according to an embodiment of this disclosure;

FIG. 13 is a further flowchart of an image decoding method according to an embodiment of this disclosure;

FIG. 14 is a schematic diagram of an image encoding apparatus according to an embodiment of this disclosure;

FIG. 15 is another schematic diagram of an image encoding apparatus according to an embodiment of this disclosure;

FIG. 16 is a schematic diagram of an image decoding apparatus according to an embodiment of this disclosure;

FIG. 17 is a schematic diagram of an image reconstructing portion according to an embodiment of this disclosure; and

FIG. 18 is a schematic diagram of an encoder or a decoder according to an embodiment of this disclosure.

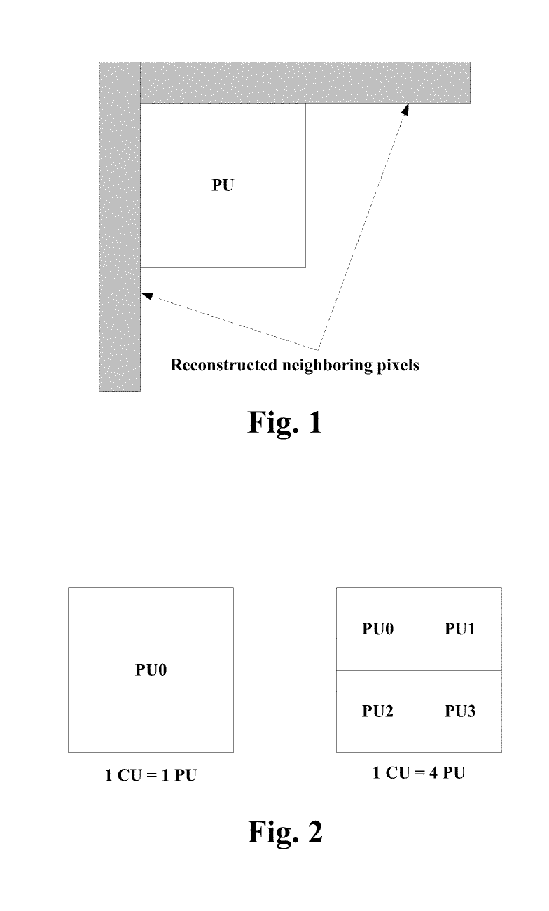

### DETAILED DESCRIPTION

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

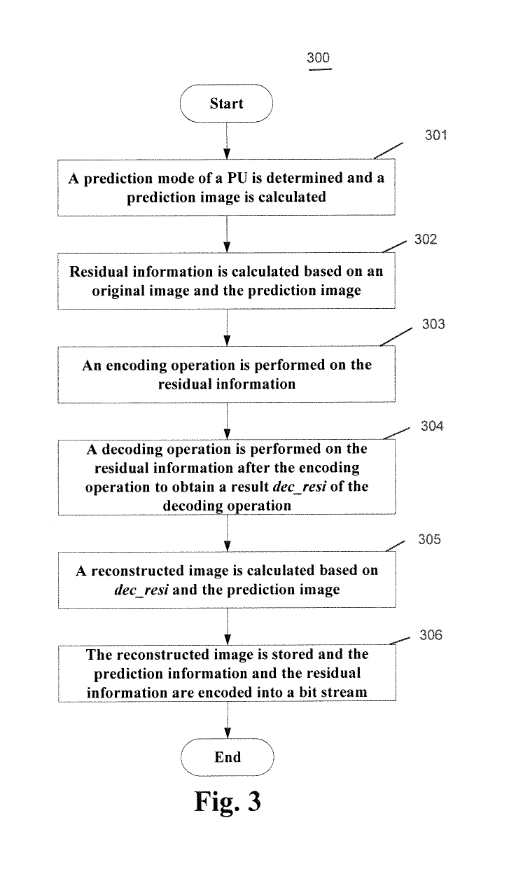

FIG. 3 is a schematic diagram of performing encoding 300 by using an intra prediction manner, in which a case where an encoding device is directed to one PU is shown. As shown in FIG. 3, for each PU, a prediction mode of the PU may be determined first, and then a prediction image is calculated at operation 301. And residual information may be calculated at operation 302 based on an original image and the prediction image.

As shown in FIG. 3, the encoding device may further perform an encoding operation on the residual information at operation 303, such as transform and quantilization operations; then at operation 304, it may perform a decoding operation on the encoding operated residual information, such as inverse quantilization (IQ) and inverse transform (IT) operations, so as to obtain a decoding operated result dec_resi; and thereafter, at operation 305, it may calculate a reconstructed image based on the dec_resi and the predication image; and the reconstructed image may be saved at operation 306 for subsequent encoding.

As shown in FIG. 3, at operation 306, the encoding device may encode information on a prediction mode and the residual information into a bit steam.

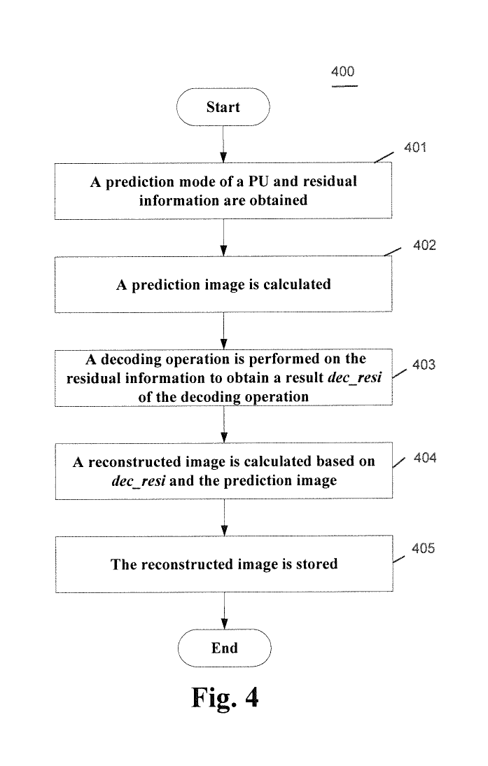

FIG. 4 is a schematic diagram of performing decoding 400 by using an intra prediction manner, in which a case where a decoding device is directed to one PU is shown. As shown in FIG. 4, the decoding device may obtain at operation 401, information on a prediction mode and residual information of each PU from a bit steam, and then it may calculate a prediction image at operation 402.

As shown in FIG. 4, the decoding device may decode the residual information at operation 403, such as performing inverse quantilization (IQ) and inverse transform (IT) operations, so as to obtain a decoding operated result dec_resi; and thereafter, at operation 404, it may calculate a reconstructed image based on the dec_resi and the predication image; and the reconstructed image may be saved at operation 405 for subsequent encoding.

It should be noted that encoding and decoding by the encoding device and the decoding device by using the intra prediction manner are illustrated above. However, this disclosure is not limited thereto; for example, the prediction mode information may be encoded into a bit stream after being determined, etc., and a particular implementation may be determined according to an actual situation. And furthermore, reference may be made to existing standards for particular contents of the information on a prediction mode and residual information and how to calculate the residual information, which shall not be described herein any further.

In the above scheme, a predicting unit is taken as a granularity in performing intra prediction, if the predicting unit is relatively large, which will result in an inaccurate prediction result, and if the predicting unit is relatively small, more information on a prediction mode and residual information need to be encoded into a bit stream, which will result in a higher cost in encoding. The embodiments of this disclosure shall be described below in detail.

### Embodiment 1

These embodiments of this disclosure provide an image encoding method, in which encoding is perform on a plurality of sub-predicting units (sub-PUs) of a predicting unit (PU) in an intra prediction manner.

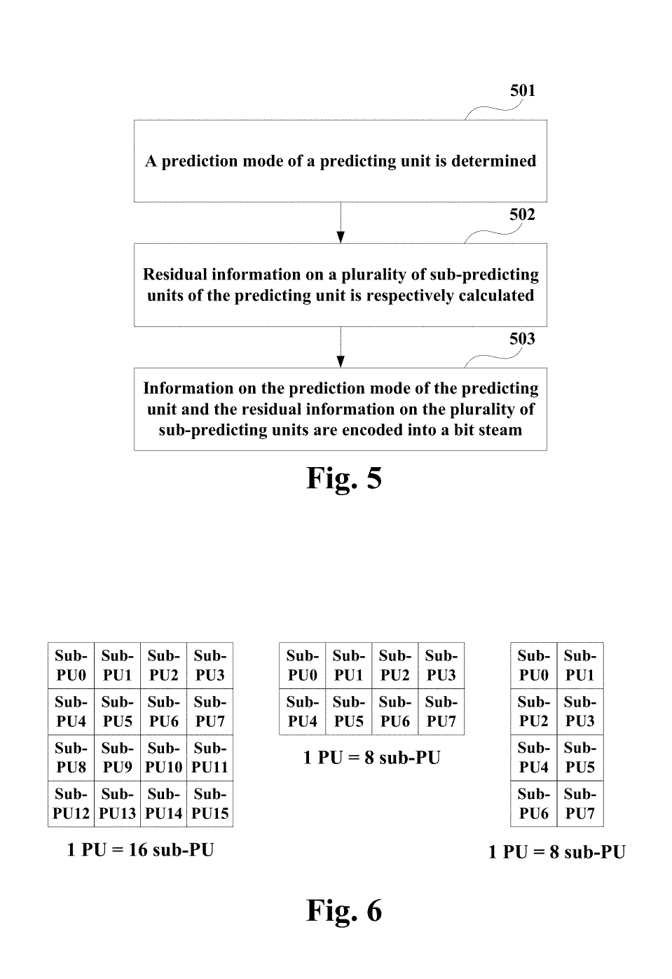

FIG. 5 is a flowchart of the image encoding method of the embodiment of this disclosure, which shall be described for a predicting unit from an encoding device. As shown in FIG. 5, the image encoding method includes:

operation 501: a prediction mode of the predicting unit is determined;

operation 502: residual information on the plurality of sub-predicting units of the predicting unit is respectively calculated; and

operation 503: information on the prediction mode of the predicting unit and the residual information on the plurality of sub-predicting units are encoded into a bit steam.

In an embodiment, a size of the sub-predicting unit may be predetermined. For example, no matter a shape of the PU is square or rectangular, or other shapes, a sub-PU may always be square and have a predefined size. Information on the size of the sub-prediction unit may be included in a sequence parameter set (SPS), or included in a picture parameter set (PPS), or may be of a predetermined value (for example, a default value).

FIG. 6 is a schematic diagram of a relationship between the PU and the sub-PUs of the embodiment of this disclosure, in which several examples are shown. As shown in FIG. 6, for example, all the PU and the sub-PUs may be square, and one PU may be divided into 16 sub-PUs. Alternatively, for example, the PU is a rectangle with its length being smaller than its width, and the sub-PUs are square, and one PU may be divided into 8 sub-PUs. Alternatively, for example, the PU is a rectangle with its length being greater than its width, and the sub-Pus are square, and one PU may be divided into 8 sub-PUs.

As shown in FIG. 6, the size and shape of the sub-PU may be fixed, for example, 4*4 (pixels*pixels) or 8*8. It should be noted that FIG. 6 only schematically shows the relationship between the PU and the sub-PUs. However, this disclosure is not limited thereto, and a particular division manner may be determined according to an actual situation.

In an embodiment, a plurality of sub-prediction units of one prediction unit correspond to the same prediction mode. That is, a plurality of sub-prediction units of the same prediction unit share the same intra prediction mode. Hence, it is unnecessary to perform bit stream encoding on the prediction mode information of each sub-prediction unit, and a cost of bit streams of the encoding will not be increased excessively. And furthermore, since the prediction unit is divided into finer prediction blocks, the accuracy of the intra prediction may be improved.

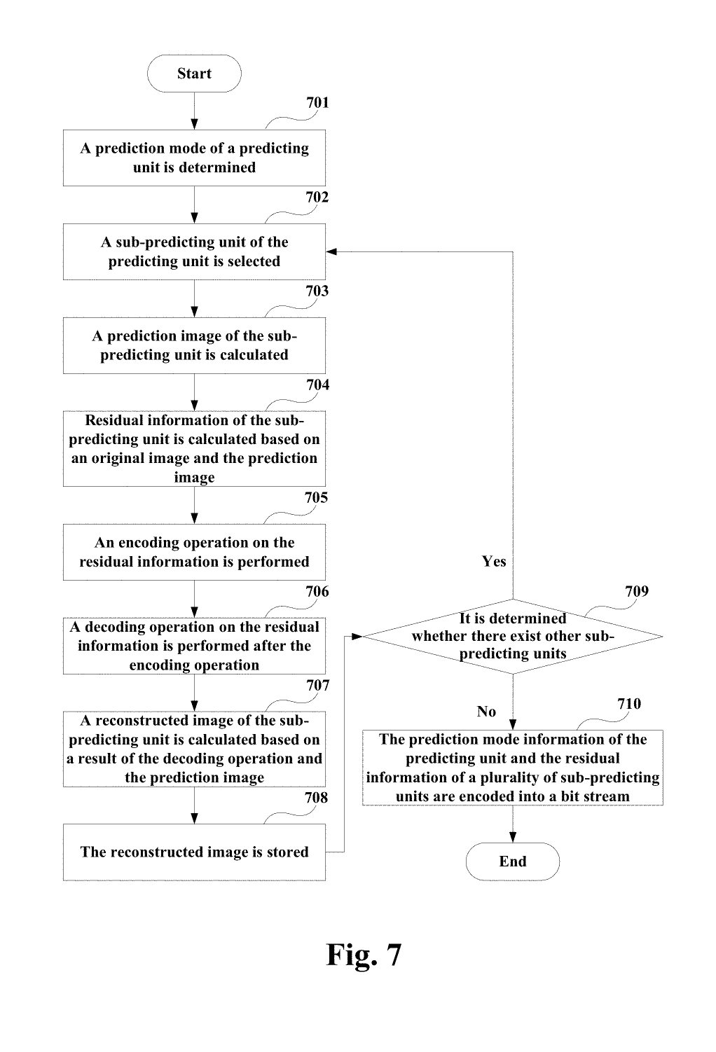

FIG. 7 is another flowchart of the image encoding method of the embodiment of this disclosure, which shall be described for a predicting unit from an encoding device. As shown in FIG. 7, the image encoding method includes:

701: a prediction mode of the predicting unit is determined.

702: a sub-predicting unit of the predicting unit is selected.

703: a prediction image of the sub-predicting unit is calculated.

For example, the prediction image may be expressed as prediction.

704: residual information of the sub-predicting unit is calculated based on an original image and the prediction image.

That is, resi=original−prediction; where, resi denotes the residual information of the sub-predicting unit, and original denotes the original image; and reference may be made to related techniques for how to calculate the residual information.

705: an encoding operation on the residual information is performed.

For example, operations such as transform and quantilization may be performed on resi; however, this disclosure is not limited thereto, and other encoding operations may also be performed. For details on how to perform encoding operations; and reference may be made to related techniques for how to perform the encoding operation.

706: a decoding operation on the residual information is performed after the encoding operation.

For example, the residual information after the encoding operation may be subjected to such operations as inverse quantilization (IQ), and inverse transform (IT), etc., and a decoded result dec_resi may be obtained; however, this disclosure is not limited thereto, and other decoding operations may also be performed; and reference may be made to related techniques for how to perform the decoding operation.

In an embodiment, since the encoding operation and the decoding operation are lossy operations, a result different from the initial resi may be obtained after blocks 705 and 706 are executed.

707: a reconstructed image of the sub-predicting unit is calculated based on a result of the decoding operation and the prediction image.

For example, reco=dec_resi+prediction; where, reco denotes the reconstructed image of the sub-predicting unit.

708: the reconstructed image is stored.

In an embodiment, the reconstructed image may be used for subsequent encoding.

709: it is determined whether there exist other sub-predicting units, executing block 702 if there exist other sub-predicting units to continue to perform processing of a next sub-predicting unit, and executing block 710 if there exist no other sub-predicting units.

710: the prediction mode information of the predicting unit and the residual information of the plurality of sub-predicting units are encoded into a bitstream; the prediction mode information of the predicting unit may be obtained in block 701, and the residual information of the plurality of sub-predicting units may be obtained in block 705.

It should be noted that FIG. and 7 only schematically shows the embodiment of this disclosure; however, this disclosure is not limited thereto. For example, an order of execution of the blocks or steps may be appropriately adjusted; and furthermore, some other blocks or steps may be added, or some of these blocks or steps may be reduced. And appropriate variants may be made by those skilled in the art according to what is described above, without being limited to the disclosure contained in the above figure.

For example, the bit stream encoding may be performed after the processing of the entire predicting unit is completed; or the bit stream encoding may be performed immediately after the prediction mode information of the predicting unit or the residual information of the plurality of sub-predicting units is determined; and a time of bit stream encoding may be determined according to an actual situation.

In an embodiment, for an order of processing of the sub-predicting units in the predicting unit, for example, a raster scan mode or a Z-type mode may be employed; however, this disclosure is not limited thereto.

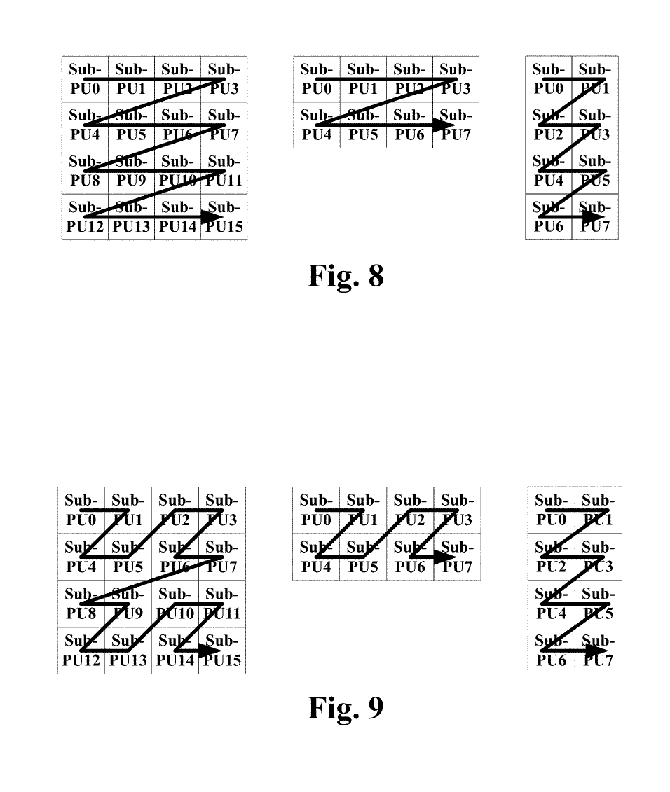

FIG. 8 is a schematic diagram of raster scan modes of the embodiment of this disclosure, showing examples of a number of raster scan modes; and FIG. 9 is a schematic diagram of Z-type scan modes of the embodiment of this disclosure, showing examples of a number of Z-type scan modes.

In an embodiment, whether the predicting unit is divided into a plurality of sub-predicting units may be indicated, and indication information indicating whether the predicting unit is divided into a plurality of sub-predicting units may be encoded into the bit stream; hence, intra prediction may be performed by adaptively taking the predicting unit as a granularity, or intra prediction may be performed by taking a sub-predicting unit as a granularity.

In an embodiment, the indication information may be, for example, a 1-bit identifier, and the following description shall be given by taking intra_sub_pu_flag as an example; wherein intra_sub_pu_flag=0 indicates that the predicting unit is not divided into a plurality of sub-predicting units, that is, intra prediction is performed by taking the predicting unit as a granularity; and intra_sub_pu_flag=1 indicates that the predicting unit is divided into a plurality of sub-predicting units, that is, intra prediction is performed by taking the sub-predicting unit as a granularity.

In an embodiment, a granularity of the indication information may be of a predicting unit (PU) level, or of a coding unit (CU) level, or of a slice level, or of a picture level, or of a sequence level; however, this disclosure is not limited thereto.

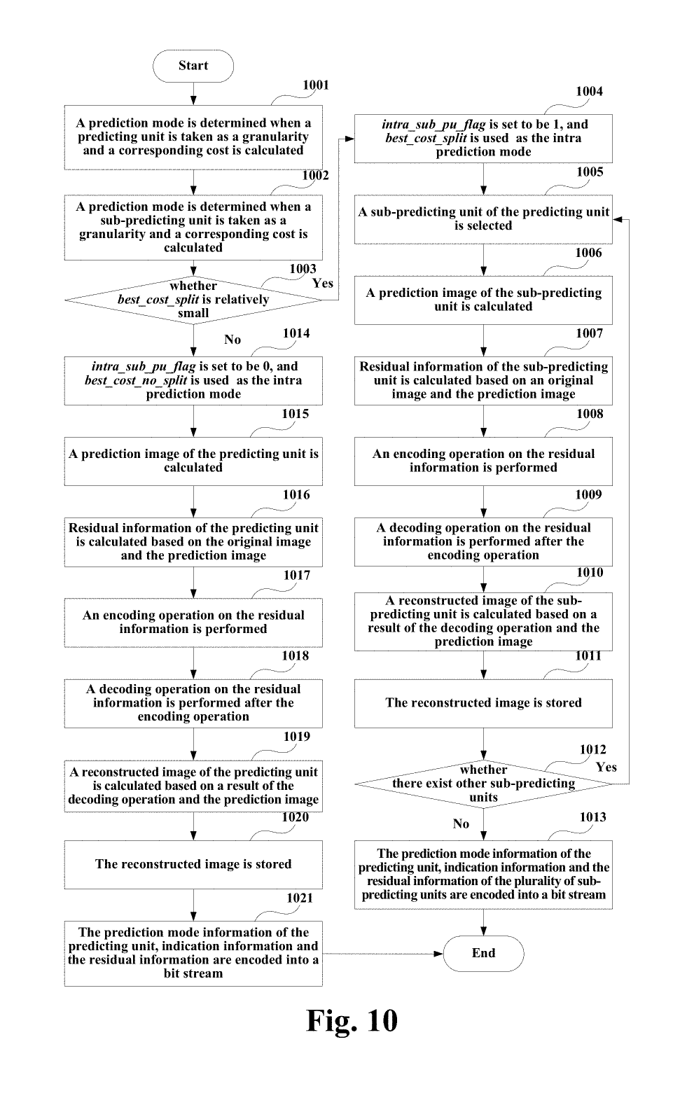

FIG. 10 is another flowchart of the image encoding method of the embodiment of this disclosure, which shall be described for a predicting unit from an encoding device, and schematically shows a case where a predicting unit (PU) level or a sub-predicting unit (sub-PU) level is adaptively taken as a granularity. As shown in FIG. 10, the image encoding method includes:

1001: a prediction mode is determined (for example, denoted by best_mode_no_split) when the predicting unit is taken as a granularity (i.e. when the predicting unit is not divided into a plurality of sub-predicting units), and a corresponding cost is calculated (for example, denoted by best_cost_no_split). 1002: a prediction mode is determined (for example, denoted by best_mode_split) when a sub-predicting unit is taken as a granularity (i.e. when the predicting unit is divided into a plurality of sub-predicting units), and a corresponding cost is calculated (for example, denoted by best_cost_split).

In an embodiment, regarding particular determination of the prediction mode and how to calculate the cost, reference may be made to related techniques.

1003: it is determined whether best cost split is smaller than best_cost_no_split, and executing block 1004 if yes, otherwise, executing block 1014.

In an embodiment, dividing into sub-predicting units is shown in blocks 1004-1013.

1004: intra_sub_pu_flag is set to be 1, and best_cost_split is used as the intra prediction mode.

1005: a sub-predicting unit of the predicting unit is selected.

1006: a prediction image of the sub-predicting unit is calculated.

For example, the prediction image may be denoted as prediction.

1007: residual information of the sub-predicting unit is calculated based on an original image and the prediction image.

That is, resi=original−prediction; where, resi denotes the residual information of the sub-predicting unit, and original denotes the original image; and regarding particular calculation of the residual information, reference may be made to related techniques.

1008: an encoding operation on the residual information is performed.

For example, resi may be subjected to such operations as transform and quantilization; however, this disclosure is not limited thereto, and it may be other encoding operations, and reference may be made to related techniques for how to perform encoding operations.

1009: a decoding operation on the residual information is performed after the encoding operation.

For example, the residual information after the encoding operation may be subjected to such operations as inverse quantilization (IQ) and inverse transform (IT), and a decoded result dec_resi may be obtained; however, this disclosure is not limited thereto, and it may be other decoding operations, and reference may be made to related techniques for how to perform decoding operations.

1010: a reconstructed image of the sub-predicting unit is calculated based on a result of the decoding operations and the prediction image. For example, reco=dec_resi+prediction; where, reco denotes the reconstructed image of the sub-predicting unit.

1011: the reconstructed image is stored.

In an embodiment, the reconstructed image may be used for subsequent encoding.

1012: it is determined whether there exist other sub-predicting units, executing block 1005 if there exist other sub-predicting units to continue to perform processing of a next sub-predicting unit, and executing block 1013 if there exist no other sub-predicting units.

1013: the prediction mode information of the predicting unit, the indication information (i.e. intra_sub_pu_flag) and the residual information of the plurality of sub-predicting units are encoded into a bit stream.

In an embodiment, not dividing into sub-predicting units is shown in blocks 1014-1021.

1014: intra_sub_pu_flag is set to be 0, and best_cost_no_split is used as the intra prediction mode.

1015: a prediction image of the predicting unit is calculated.

For example, the prediction image may be denoted as prediction.

1016: residual information of the predicting unit is calculated based on the original image and the prediction image.

That is, resi=original−prediction; where, resi denotes the residual information of the predicting unit, original denotes the original image; and reference may be made to the related techniques for how to calculate the residual information.

1017: an encoding operation on the residual information is performed.

For example, the resi may be subjected to such operations as transform and quantilization; however, this disclosure is not limited thereto, and it may be other encoding operations, and reference may be made to related techniques for how to perform encoding operations.

1018: a decoding operation on the residual information is performed after the encoding operation.

For example, the residual information after the encoding operation may be subjected to such operations as inverse quantilization (IQ) and inverse transform (IT);

however, this disclosure is not limited thereto, and it may be other decoding operations, and reference may be made to related techniques for how to perform decoding operations.

1019: a reconstructed image of the predicting unit is calculated based on a result of the decoding operations and the prediction image.

For example, reco=dec_resi+prediction; where, reco denotes the reconstructed image of the predicting unit.

1020: the reconstructed image is stored.

In an embodiment, the reconstructed image may be used for subsequent encoding. 1021: the prediction mode information of the predicting unit, the indication information (i.e. intra_sub_pu_flag) and the residual information are encoded into a bit stream.

It is to be noted that the embodiment of this disclosure is illustrated in FIG. 10; however, this disclosure is not limited thereto. For example, an order of execution of the blocks or steps may be appropriately adjusted; and furthermore, some other blocks or steps may be added, or some of these blocks or steps may be reduced. And appropriate variants may be made by those skilled in the art according to what is described above, without being limited to the disclosure contained in the above figures.

In addition, this disclosure is schematically illustrated by taking only one predicting unit as an example, and a plurality of predicting units may be encoded using the above blocks or steps respectively. The blocks or steps or processes related to this disclosure are only described above. However, this disclosure is not limited thereto; and the image encoding method may further include other blocks or steps or processes, and reference may be made to the relevant art for particular contents of these blocks or steps or processes.

It can be seen from the above embodiments that the prediction mode of the predicting unit is determined, residual information on the plurality of sub-predicting units of the predicting unit is respectively calculated, and information on the prediction mode of the predicting unit and the residual information on the plurality of sub-predicting units are encoded into a bit steam. Hence, an intra prediction result may be provided more accurately without increasing overmuch encoding cost.

### Embodiment 2

These embodiments of this disclosure provide an image decoding method, in which decoding is perform on a plurality of sub-predicting units (sub-PUs) of a predicting unit (PU) in an intra prediction manner. And these embodiments correspond to the image encoding method in Embodiment 1, with contents identical those in Embodiment 1 being not going to be described herein any further.

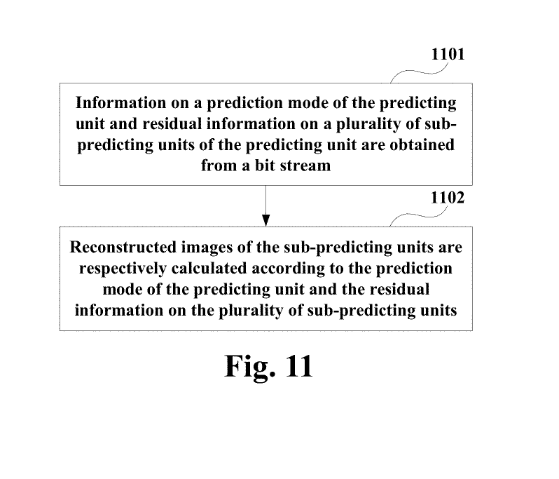

FIG. 11 is a flowchart of the image decoding method of the embodiment of this disclosure, which shall be described for a predicting unit from a decoding device. As shown in FIG. 11, the image decoding method includes:

1101: information on a prediction mode of the predicting unit and residual information on the plurality of sub-predicting units of the predicting unit are obtained from a bit stream; and

1102: reconstructed images of the sub-predicting units are respectively calculated according to the prediction mode of the predicting unit and the residual information on the plurality of sub-predicting units.

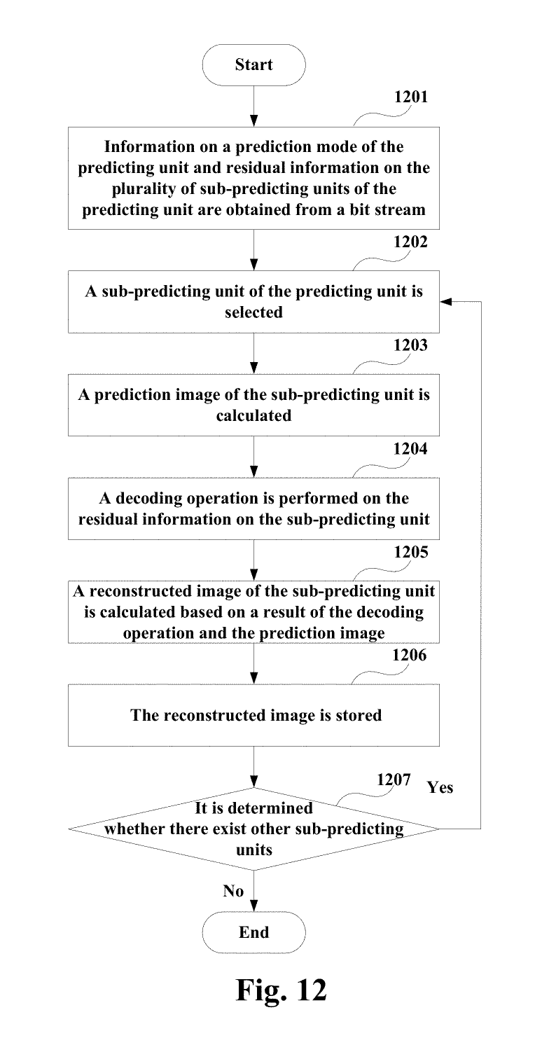

FIG. 12 is another flowchart of the image decoding method of the embodiment of this disclosure, which shall be described for a predicting unit from a decoding device. As shown in FIG. 12, the image decoding method includes:

1201: information on a prediction mode of the predicting unit and residual information on the plurality of sub-predicting units of the predicting unit are obtained from a bit stream.

As shown in FIG. 12, the image decoding method may further include:

1202: a sub-predicting unit of the predicting unit is selected.

1203: a prediction image of the sub-predicting unit is calculated.

For example, the prediction image may be expressed as prediction.

1204: a decoding operation is performed on the residual information on the sub-predicting units.

For example, the residual information may be subjected to such operations as inverse quantilization (IQ), and inverse transform (IT), etc., and a decoded result dec_resi may be obtained; however, this disclosure is not limited thereto, and other decoding operations may also be performed; and reference may be made to related techniques for how to perform the decoding operation.

1205: a reconstructed image of the sub-predicting unit is calculated based on a result of the decoding operation and the prediction image.

For example, reco=dec_resi+prediction; where, reco denotes the reconstructed image of the sub-predicting unit.

1206: the reconstructed image is stored.

In an embodiment, the reconstructed image may be used for subsequent decoding.

1207: it is determined whether there exist other sub-predicting units, executing block 1202 if there exist other sub-predicting units to continue to perform processing of a next sub-predicting unit, and performing processing of a current predicting unit if there exist no other sub-predicting units.

In an embodiment, whether the predicting unit is divided into a plurality of sub-predicting units may be indicated, and indication information indicating whether the predicting unit is divided into a plurality of sub-predicting units may be encoded into the bit stream; hence, intra prediction may be performed by adaptively taking the predicting unit as a granularity, or intra prediction may be performed by taking a sub-predicting unit as a granularity.

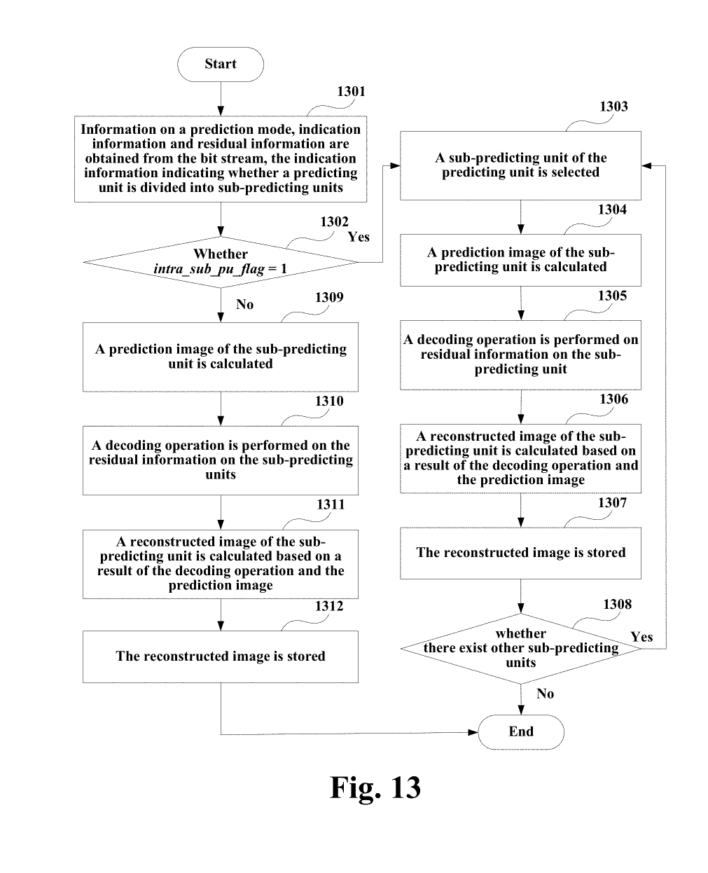

FIG. 13 is another flowchart of the image decoding method of the embodiment of this disclosure, which shall be described for a predicting unit from a decoding device. As shown in FIG. 13, the image decoding method includes:

1301: information on a prediction mode, indication information and residual information are obtained from the bit stream, the indication information (for example, it is denoted by intra_sub_pu_flag) indicating whether a predicting unit is divided into sub-predicting units.

1302: it is determined whether intra_sub_pu_flag is equal to 1, and executing block 1303 if yes, otherwise, executing block 1309.

In an embodiment, description shall be given by taking intra_sub_pu_flag as an example; wherein, intra_sub_pu_flag=0 denotes that the predicting unit is not divided into sub-predicting units, that is, the intra prediction is performed by taking the predicting unit as a granularity; and intra_sub_pu_flag=1 denotes that the predicting unit is divided into a plurality of sub-predicting units, that is, the intra prediction is performed by taking a sub-predicting unit as a granularity.

In an embodiment, dividing into sub-predicting units is shown in blocks 1303-1308.

1303: a sub-predicting unit of the predicting unit is selected.

1304: a prediction image of the sub-predicting unit is calculated.

For example, the prediction image may be expressed as prediction.

1305: a decoding operation is performed on residual information on the sub-predicting units.

For example, the residual information may be subjected to such operations as inverse quantilization (IQ), and inverse transform (IT), etc., and a decoded result dec_resi may be obtained; however, this disclosure is not limited thereto, and other decoding operations may also be performed; and reference may be made to related techniques for how to perform the decoding operation.

1306: a reconstructed image of the sub-predicting unit is calculated based on a result of the decoding operation and the prediction image.

For example, reco=dec_resi+prediction; where, reco denotes the reconstructed image of the sub-predicting unit.

1307: the reconstructed image is stored.

In an embodiment, the reconstructed image may be used for subsequent decoding.

1308: it is determined whether there exist other sub-predicting units, executing block 1303 if there exist other sub-predicting units to continue to perform processing of a next sub-predicting unit, and performing processing of a current predicting unit if there exist no other sub-predicting units.

In an embodiment, not dividing into sub-predicting units is shown in blocks 1309-1312.

1309: a prediction image of the sub-predicting unit is calculated.

For example, the prediction image may be expressed as prediction.

1310: a decoding operation is performed on the residual information on the sub-predicting units.

For example, the residual information may be subjected to such operations as inverse quantilization (IQ), and inverse transform (IT), etc.; however, this disclosure is not limited thereto, and other decoding operations may also be performed; and reference may be made to related techniques for how to perform the decoding operation.

1311: a reconstructed image of the sub-predicting unit is calculated based on a result of the decoding operation and the prediction image.

For example, reco=dec_resi+prediction; where, reco denotes the reconstructed image of the predicting unit.

1312: the reconstructed image is stored.

In an embodiment, the reconstructed image may be used for subsequent decoding.

It is to be noted that the embodiment of this disclosure is illustrated in FIG. 13; however, this disclosure is not limited thereto. For example, an order of execution of the blocks or steps may be appropriately adjusted; and furthermore, some other blocks or steps may be added, or some of these blocks or steps may be reduced. And appropriate variants may be made by those skilled in the art according to what is described above, without being limited to the disclosure contained in the above figures.

In addition, this disclosure is schematically illustrated by taking only one predicting unit as an example, and a plurality of predicting units may be decoded using the above blocks or steps respectively. The blocks or steps or processes related to this disclosure are only described above. However, this disclosure is not limited thereto; and the image decoding method may further include other blocks or steps or processes, and reference may be made to the relevant art for particular contents of these blocks or steps or processes.

It can be seen from the above embodiments that the prediction mode of the predicting unit is determined, residual information on the plurality of sub-predicting units of the predicting unit is respectively calculated, and information on the prediction mode of the predicting unit and the residual information on the plurality of sub-predicting units are encoded into a bit steam. Hence, an intra prediction result may be provided more accurately without increasing overmuch encoding cost.

### Embodiment 3

These embodiments of this disclosure provide an image encoding apparatus, which is configured to perform encoding on a plurality of sub-predicting units of a predicting unit in an intra prediction manner. And these embodiments correspond to the image encoding method in Embodiment 1, with identical contents being not going to be described herein any further.

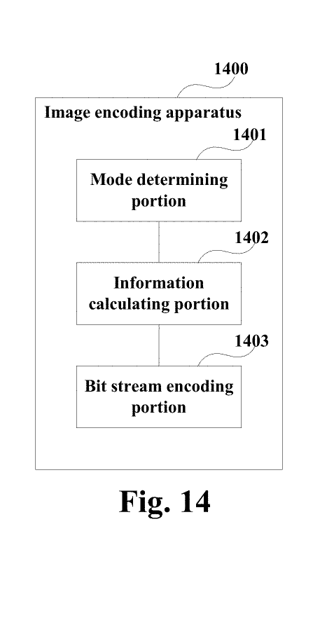

FIG. 14 is a schematic diagram of the image encoding apparatus of the embodiment of this disclosure. As shown in FIG. 14, an image encoding apparatus 1400 includes:

a mode determining portion 1401 configured to determine a prediction mode of the predicting unit;

an information calculating portion 1402 configured to respectively calculate residual information on the plurality of sub-predicting units of the predicting unit; and

a bit stream encoding portion 1403 configured to encode information on the prediction mode of the predicting unit and the residual information on the plurality of sub-predicting units into a bit steam.

In an embodiment, a size of the sub-predicting unit may be predetermined, and information on the size of the sub-predicting unit may be contained in a sequence parameter set, or may be contained in a picture parameter set, or may be a predetermined value; however, this disclosure is not limited thereto.

In an embodiment, the plurality of sub-predicting units of the predicting unit correspond to the same prediction mode.

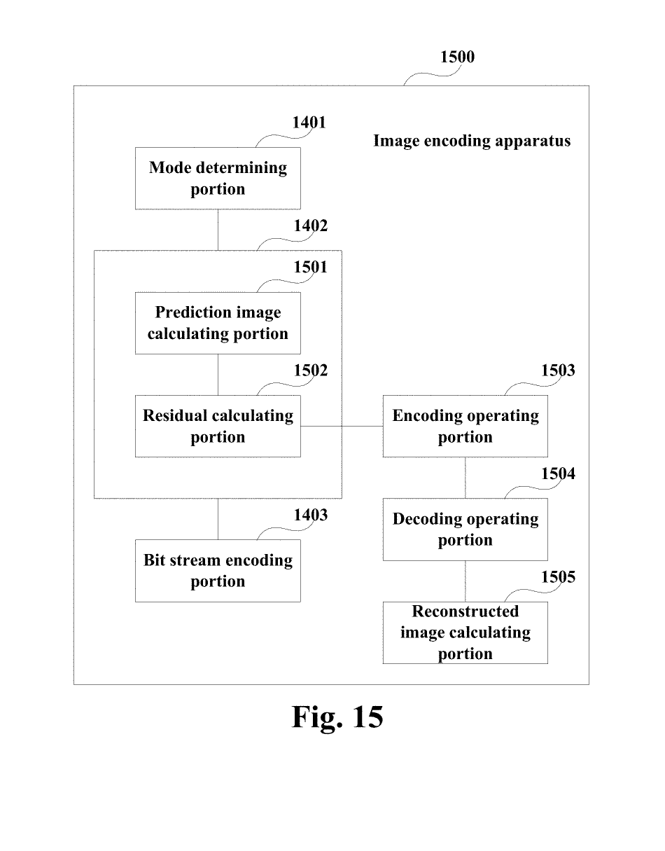

FIG. 15 is another schematic diagram of the image encoding apparatus of the embodiment of this disclosure. As shown in FIG. 15, an image encoding apparatus 1500 includes a mode determining portion 1401, an information calculating portion 1402 and a bit stream encoding portion 1403, as described above.

As shown in FIG. 15, the information calculating portion 1402 may include:

a prediction image calculating portion 1501 configured to, for each of the sub-predicting units, calculate a prediction image of the sub-predicting unit; and

a residual calculating portion 1502 configured to calculate residual information on the sub-predicting unit based on an original image and the prediction image.

As shown in FIG. 15, the image encoding apparatus 1500 may further include:

an encoding operating portion 1503 configured to perform an encoding operation on the residual information;

a decoding operating portion 1504 configured to perform a decoding operation on the encoding operated residual information; and

a reconstructed image calculating portion 1505 configured to calculate a reconstructed image of the sub-predicting unit based on a result of the decoding operation and the prediction image.

In an embodiment, the bit stream encoding portion 1403 may further be configured to encode indication information into the bit stream, the indication information indicating whether the predicting unit is divided into a plurality of sub-predicting units.

In an embodiment, the indication information may be identification of one bit;

however, this disclosure is not limited thereto. A granularity of the indication information may be of a predicting unit level, or may be a coding unit level, or may be a slice level, or may be an image level, or may be a sequence level.

It should be noted that the components related to this disclosure are only described above. However, the image encoding apparatus may further include other components or modules, and reference may be made to the relevant art for particular contents of these components or modules.

It can be seen from the above embodiments that the prediction mode of the predicting unit is determined, residual information on the plurality of sub-predicting units of the predicting unit is respectively calculated, and information on the prediction mode of the predicting unit and the residual information on the plurality of sub-predicting units are encoded into a bit steam. Hence, an intra prediction result may be provided more accurately without increasing overmuch encoding cost.

### Embodiment 4

These embodiments of this disclosure provide an image decoding apparatus, which is configured to perform decoding on a plurality of sub-predicting units of a predicting unit in an intra prediction manner. And these embodiments correspond to the image decoding method in Embodiment 2, with identical contents being not going to be described herein any further.

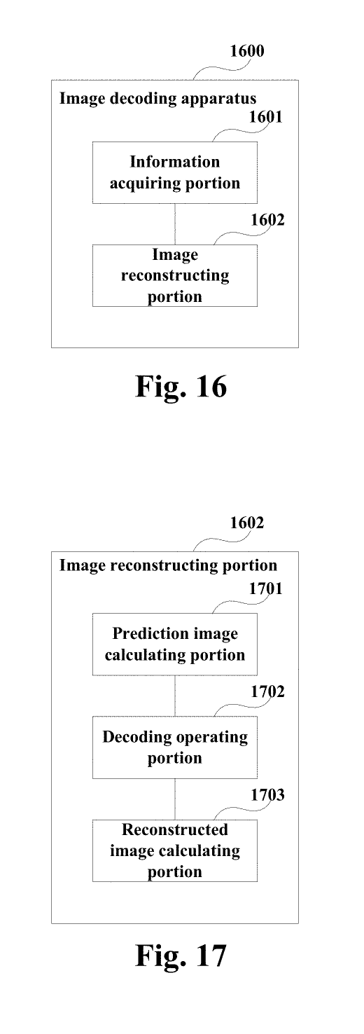

FIG. 16 is a schematic diagram of the image decoding apparatus of the embodiment of this disclosure. As shown in FIG. 16, an image decoding apparatus 1600 includes:

an information acquiring portion 1601 configured to obtain information on a prediction mode of the predicting unit and residual information on a plurality of sub-predicting units of the predicting unit from a bit stream; and

an image reconstructing portion 1602 configured to respectively calculate reconstructed images of the sub-predicting units according to the prediction mode of the predicting unit and the residual information on the plurality of sub-predicting units.

FIG. 17 is a schematic diagram of the image reconstructing portion of the embodiment of this disclosure. As shown in FIG. 17, the image reconstructing portion 1602 may include:

a prediction image calculating portion 1701 configured to, for each of the sub-predicting units, calculate a prediction image of the sub-predicting unit;

a decoding operating portion 1702 configured to perform a decoding operation on the residual information on the sub-predicting units; and

a reconstructed image calculating portion 1703 configured to calculate a reconstructed image of the sub-predicting unit based on a result of the decoding operation and the prediction image.

In an embodiment, the information acquiring portion 1601 may further be configured to obtain indication information from the bit stream, the indication information indicating whether the predicting unit is divided into a plurality of sub-predicting units.

In a case where the indication information indicates that the predicting unit is not divided into a plurality of sub-predicting units, the image reconstructing portion 1701 may further be configured to calculate a reconstructed image of the predicting unit, the decoding operating portion 1702 may further be configured to perform a decoding operation on the residual information on the predicting unit, and reconstructed image calculating portion 1703 may further be configured to calculate the reconstructed image of the predicting unit based on the result of the decoding operation and the prediction image.

It should be noted that the components related to this disclosure are only described above. However, the image decoding apparatus may further include other components or modules, and reference may be made to the relevant art for particular contents of these components or modules.

It can be seen from the above embodiments that the prediction mode of the predicting unit is determined, residual information on the plurality of sub-predicting units of the predicting unit is respectively calculated, and information on the prediction mode of the predicting unit and the residual information on the plurality of sub-predicting units are encoded into a bit steam. Hence, an intra prediction result may be provided more accurately without increasing overmuch encoding cost.

### Embodiment 5

These embodiments of this disclosure provide an image processing equipment, including an encoder and a decoder; the encoder includes the image encoding apparatus as described in Embodiment 3, and the decoder includes the image decoding apparatus as described in Embodiment 4.

The embodiment of this disclosure further provides an encoder.

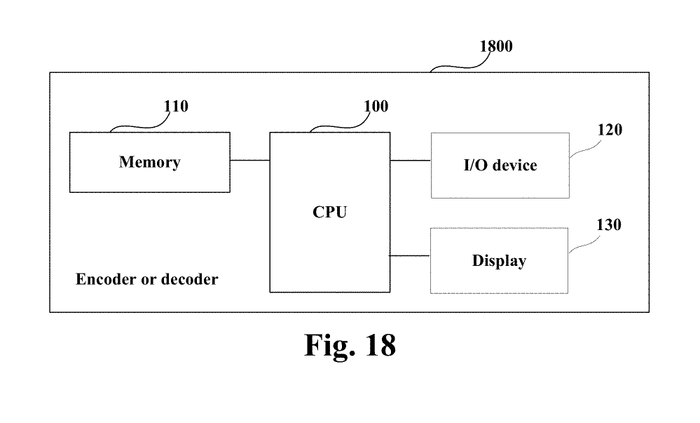

FIG. 18 is a schematic diagram of the encoder of the embodiment of this disclosure. As shown in FIG. 18, an encoder 1800 may include a central processing unit (CPU) 100 and a memory 110, the memory 110 being coupled to the central processing unit 100. The memory 110 may store various data, and furthermore, it may store a program for information processing, and execute the program under control of the central processing unit 100.

In an embodiment, the functions of the image encoding apparatus 1400 or 1500 may be integrated into the central processing unit 100. The central processing unit 100 may be configured to carry out the mage encoding method described in Embodiment 1.

In another embodiment, the image encoding apparatus 1400 or 1500 and the central processing unit 100 may be configured separately. For example, the image encoding apparatus 1400 or 1500 may be configured as a chip connected to the central processing unit 100, with its functions being carried out under control of the central processing unit 100.

For example, the central processing unit 100 may be configured to perform following control: determining a prediction mode of the predicting unit; respectively calculating residual information on a plurality of sub-predicting units of the predicting unit; and encoding information on the prediction mode of the predicting unit and the residual information on the plurality of sub-predicting units into a bit steam.

Furthermore, as shown in FIG. 18, the encoder 1800 may include an input/output (I/O) device 120, and a display 130, etc. Functions of the above components are similar to those in the relevant art, and shall not be described herein any further. It should be noted that the encoder 1800 does not necessarily include all the parts shown in FIG. 18, and furthermore, the encoder 1800 may include parts not shown in FIG. 18, and the relevant art may be referred to.

The embodiment of this disclosure further provides a decoder, reference being able to be made to FIG. 18 for a structure of the decoder.

For example, the central processing unit 100 may be configured to perform following control: obtaining information on a prediction mode of the predicting unit and residual information on the plurality of sub-predicting units of the predicting unit from a bit stream; and respectively calculating reconstructed images of the sub-predicting units according to the prediction mode of the predicting unit and the residual information on the plurality of sub-predicting units.

An embodiment of the present disclosure provides a computer readable program code, which, when executed in an image encoding apparatus or image processing equipment, will cause the image encoding apparatus or the image processing equipment to carry out the image encoding method described in Embodiment 1.

An embodiment of the present disclosure provides a storage medium, including a computer readable program code, which will cause an image encoding apparatus or image processing equipment to carry out the image encoding method described in Embodiment 1.

An embodiment of the present disclosure provides a computer readable program code, which, when executed in an image decoding apparatus or image processing equipment, will cause the image decoding apparatus or the image processing equipment to carry out the image decoding method described in Embodiment 2.

An embodiment of the present disclosure provides a storage medium, including a computer readable program code, which will cause an image decoding apparatus or image processing equipment to carry out the image decoding method described in Embodiment 2.

The above apparatuses and method of this disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory.

The method/apparatus described with reference to the embodiments of this disclosure may be directly embodied as hardware, software modules executed by a processor, or a combination thereof. For example, one or more functional block diagrams and/or one or more combinations of the functional block diagrams shown in FIG. 14 may either correspond to software modules of procedures of a computer program, or correspond to hardware modules. Such software modules may respectively correspond to the steps shown in FIG. 5. And the hardware module, for example, may be carried out by firming the soft modules by using a field programmable gate array (FPGA).

The soft modules may be located in an RAM, a flash memory, an ROM, an EPROM, and an EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the figures may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the figures may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

For implementations of this disclosure containing the above embodiments, following supplements are further disclosed.

Supplement 1. An image encoding method, in which encoding is performed on a plurality of sub-predicting units of a predicting unit in an intra prediction manner, the image encoding method including:

determining a prediction mode of the predicting unit;

respectively calculating residual information on the plurality of sub-predicting units of the predicting unit; and

encoding information on the prediction mode of the predicting unit and the residual information on the plurality of sub-predicting units into a bit steam.

Supplement 2. The image encoding method according to supplement 1, wherein a size of the sub-predicting unit is predetermined.

Supplement 3. The image encoding method according to supplement 2, wherein information on the size of the sub-predicting unit is contained in a sequence parameter set, or is contained in a picture parameter set, or is a predetermined value.

Supplement 4. The image encoding method according to supplement 1, wherein the plurality of sub-predicting units of the predicting unit correspond to the same prediction mode.

Supplement 5. The image encoding method according to supplement 1, wherein the respectively calculating residual information on the plurality of sub-predicting units of the predicting unit includes:

for each of the sub-predicting units, calculating a prediction image of the sub-predicting unit; and

calculating residual information on the sub-predicting unit based on an original image and the prediction image.

Supplement 6. The image encoding method according to supplement 5, wherein the image encoding method further includes:

performing an encoding operation on the residual information;

performing a decoding operation on the encoding operated residual information; and

calculating a reconstructed image of the sub-predicting unit based on a result of the decoding operation and the prediction image.

Supplement 7. The image encoding method according to supplement 1, wherein the image encoding method further includes:

encoding indication information into the bit stream, the indication information indicating whether the predicting unit is divided into a plurality of sub-predicting units.

Supplement 8. The image encoding method according to supplement 7, wherein the indication information is identification of one bit.

Supplement 9. The image encoding method according to supplement 7, wherein a granularity of the indication information is of a predicting unit level, or a coding unit level, or a slice level, or an image level, or a sequence level.

Supplement 10. An image decoding method, in which decoding is performed on a plurality of sub-predicting units of a predicting unit in an intra prediction manner, the image decoding method including:

obtaining information on a prediction mode of the predicting unit and residual information on the plurality of sub-predicting units of the predicting unit from a bit stream; and

respectively calculating reconstructed images of the sub-predicting units according to the prediction mode of the predicting unit and the residual information on the plurality of sub-predicting units.

Supplement 11. The image decoding method according to supplement 10, wherein the respectively calculating reconstructed images of the sub-predicting units according to the prediction mode of the predicting unit and the residual information on the plurality of sub-predicting units includes:

for each of the sub-predicting units, calculating a prediction image of the sub-predicting unit;

performing a decoding operation on the residual information on the sub-predicting units; and

calculating a reconstructed image of the sub-predicting unit based on a result of the decoding operation and the prediction image.

Supplement 12. The image decoding method according to supplement 10, wherein a size of the sub-predicting unit is predetermined.

Supplement 13. The image decoding method according to supplement 12, wherein information on the size of the sub-predicting unit is contained in a sequence parameter set, or is contained in a picture parameter set, or is a predetermined value.

Supplement 14. The image decoding method according to supplement 10, wherein the plurality of sub-predicting units of the predicting unit correspond to the same prediction mode.

Supplement 15. The image decoding method according to supplement 10, wherein the image decoding method further includes:

obtaining indication information from the bit stream, the indication information indicating whether the predicting unit is divided into a plurality of sub-predicting units.

Supplement 16. The image decoding method according to supplement 15, wherein the indication information is identification of one bit.

Supplement 17. The image decoding method according to supplement 15, wherein a granularity of the indication information is of a predicting unit level, or a coding unit level, or a slice level, or an image level, or a sequence level.

Supplement 18. The image decoding method according to supplement 15, wherein the image decoding method further includes:

calculating a reconstructed image of the predicting unit according to the predication mode and residual information of the predicting unit when the indication information indicates that the predicting unit is not divided into a plurality of sub-predicting units.

What is claimed is:

1. An image encoding apparatus, which is configured to perform encoding on a plurality of sub-predicting units of a predicting unit in an intra prediction manner, the image encoding apparatus comprising:
at least one processor configured to:
determine a prediction mode of the predicting unit;
calculate residual information associated the plurality of sub-predicting units of the predicting unit, respectively; and
a bit stream encoder configured to encode information associated with the prediction mode of the predicting unit and the residual information associated with the plurality of sub-predicting units into a bit steam.

2. The image encoding apparatus according to claim 1, wherein a size of a respective sub-predicting unit among the plurality of sub-predicting units of the predicting unit is predetermined.

3. The image encoding apparatus according to claim 2, wherein information on the size of the respective sub-predicting unit is contained in a sequence parameter set, a picture parameter set, or is a predetermined value.

4. The image encoding apparatus according to claim 1, wherein the plurality of sub-predicting units of the predicting unit correspond to the same prediction mode.

5. The image encoding apparatus according to claim 1, wherein the calculation by the at least one processor comprises:
calculating, for each of the plurality of sub-predicting units, a prediction image of the sub-predicting units, respectively, and
calculating residual information associated with a respective sub-predicting unit based on an original image and the prediction image corresponding to the respective sub-predicting unit.

6. The image encoding apparatus according to claim 5, wherein the image encoding apparatus further:
performs an encoding operation on the residual information;
performs a decoding operation on the encoded residual information; and
calculates a reconstructed image of the respective sub-predicting unit based on a result of the decoding operation and the prediction image.

7. The image encoding apparatus according to claim 1, wherein the bit stream encoder is further configured to encode indication information into the bit stream, the indication information indicating whether the predicting unit is divided into a plurality of sub-predicting units.

8. The image encoding apparatus according to claim 7, wherein the indication information is identification of one bit.

9. The image encoding apparatus according to claim 7, wherein a granularity of the indication information is of a predicting unit level, or a coding unit level, or a slice level, or an image level, or a sequence level.

10. An image decoding apparatus, which is configured to perform decoding on a plurality of sub-predicting units of a predicting unit in an intra prediction manner, the image decoding apparatus comprising:
at least one processor configured to:
obtain information associated with a prediction mode of the predicting unit and residual information associated with the plurality of sub-predicting units of the predicting unit from a bit stream, and
calculate reconstructed images of the plurality of sub-predicting units, respectively, according to the prediction mode of the predicting unit and the residual information corresponding to the plurality of sub-predicting units.

11. The image decoding apparatus according to claim 10, wherein the calculation of the reconstructed images comprises:
calculating, for each of the plurality of sub-predicting units, a prediction image of the sub-predicting units, respectively;
performing a decoding operation on the residual information associated with the sub-predicting units; and
calculating a reconstructed image of a respective sub-predicting unit based on a result of the decoding operation and the prediction image.

12. The image decoding apparatus according to claim 10, wherein a size of a respective sub-predicting unit among the plurality of sub-predicting units of the predicting unit is predetermined.

13. The image decoding apparatus according to claim 12, wherein information on the size of the respective sub-predicting unit is contained in a sequence parameter set, or is contained in a picture parameter set, or is a predetermined value.

14. The image decoding apparatus according to claim 10, wherein the plurality of sub-predicting units of the predicting unit correspond to the same prediction mode.

15. The image decoding apparatus according to claim 10, wherein the at least one processor is further configured to obtain indication information from the bit stream, the indication information indicating whether the predicting unit is divided into a plurality of sub-predicting units.

16. The image decoding apparatus according to claim 15, wherein the indication information is identification of one bit.

17. The image decoding apparatus according to claim 15, wherein a granularity of the indication information is of a predicting unit level, or a coding unit level, or a slice level, or an image level, or a sequence level.

18. The image decoding apparatus according to claim 15, wherein the image reconstructing portion is further configured to calculate a reconstructed image of the predicting unit according to the predication mode and residual information associated with the predicting unit when the indication information indicates that the predicting unit is not divided into a plurality of sub-predicting units.

19. An image processing equipment, comprising:
an encoder comprising the image encoding apparatus as claimed in claim 1; and/or
a decoder comprising the image decoding apparatus as claimed in claim 10.
